(19) United States
(12) Patent Application Publication
(10) Pub. No.: US 2011/0144797 A1
(43) Pub. Date: Jun. 16, 2011

(54) MACHINE FOR PERSONALISING CHIP CARDS AT A HIGH PROCESSING RATE

(75) Inventors: Benoït Berthe, Orleans (FR); Sarah Suzanne, Montrond les Bains (FR)

(73) Assignee: DATACARD CORPORATION, Minnetonka, MN (US)

(21) Appl. No.: 12/666,140

(22) PCT Filed: Jun. 24, 2008
(86) PCT No.: PCT/IB08/01647

§ 371 Date: Sep. 8, 2010

(30) Foreign Application Priority Data
Jun. 27, 2007 (FR) 07 04611

(51) Int. Cl. G06K 17/00

(52) U.S. Cl. 700/215

(57) ABSTRACT

A machine for the personalising of chip cards (5) that includes a computer control system (1) fitted with first communication means (21) to send personalising data, at least one rotating device (3) with portable object (5) slots (32), and means for routing the personalising data to the slots (32). Each of the slots is equipped with means to communicate with an electronic chip on one of the portable objects. A rotating connection element (6) is used exclusively for the electrical powering of the rotating device (3), while second communication means (22) fitted in the device (3) remotely receive the personalising data transmitted by the system (1) via the first means (21) The transmission of data is therefore accomplished wirelessly with a. bit-rate that can exceed 1 Gbit/s, which renders the processing rate very high in a machine with a rotating device.

### TECHNICAL FIELD OF THE INVENTION

The present invention relates to the field of electronic personalising of chip cards. More particularly, the invention relates to a compact and reliable electronic personalising machine that is used to personalise a large number of chip cards at high data-transfer rates.

### TECHNOLOGICAL BACKGROUND OF THE INVENTION

We are familiar with systems for the personalising of portable objects such as chip cards, and in particular the chip cards described as “intelligent”, that is those that include a microprocessor or a micro-calculator. In a card personalising system, several operations can be effected, which include operations for relief marking of the card, printing on one or more surfaces of the cards, or electronic personalising of the memory by means of electrical contacts or magnetic strips, or so-called contactless devices such as a radio antenna or an induction system, or for checking the cards at the end of the personalising procedure.

Document EP 1 228 481 describes a card production system that is used to program integrated circuit (chip) cards using a mechanism that includes several card programming positions which move along an axis of rotation. A rotating turret can be provided for insertion of the cards into the programming positions, and for removal of the fully programmed cards. This type of system can be used to produce 3000 cards per hour. However, the use of a rotating turret, which is fragile and easily maladjusted, can raise reliability problems.

Patent FR 97 09643 describes an electronic personalising drum with several processing slots, which transports the cards on a conveyor, and processes them as it rotates. Having several processing slots then allows the production of processed cards at a higher processing rate than would be achieved by processing in a single slot.

Patent EP 0 797 167 describes a rotating platform forming a drum that is equipped with a plurality of connection devices, and an electronic processing card associated with each connection device. The use of this type of drum avoids the use of fragile and easily maladjusted handling arms for bringing the chip cards to be personalised to the processing slots when the personalising positions are static. Each of the cards to be personalised is connected in a network to the on-board electronic processing card mounted in the rack of the rotating platform. This electronic card can be part of an integrated personal computer (PC). The electronic processing card is generally linked to a fixed computer of the PC type located other than in the drum. The link between the on-board system in rotation and the fixed installation is provided by a rotating collector. Connection is achieved via fixed contacts attached to the static part of the machine making contact with a set of rotating tracks attached to the rotating table. Likewise, the power supplies, necessary for operation of the equipment mounted on the rotating table, are provided via fixed contacts which press against the power-supply tracks. The software that controls the personalising of cards loaded onto the drum can also be used to control the ink marking process.

A drawback of the drum-type installations is that the rotating electronic connections do not allow the transmission of data at a high bit-rate to the electronic processing cards. The bit-rate is of the order of several tens of kilobits per second and thus remains well below 1 Gbit/s (gigabit per second). There is therefore a need to increase the processing rate of the personalising machines by faster transfer of the data to the cards to be personalised.

### GENERAL DESCRIPTION OF THE INVENTION

The purpose of the present invention is therefore to overcome one or more of the drawbacks of the prior art by proposing a personalising machine that allows the personalising, at a high processing rate, of chip cards of any type (or similar portable personalisable objects), that is smaller in size, and in the form of a mechanically reliable device.

To this end, the invention relates to a high processing rate personalising machine for portable objects equipped with a chip, which includes a computer controlled system fitted with first communication means to send personalising data, and addressee data in order to route the personalising data to one of the portable objects, at least one mobile device fitted with moving slots for portable objects, and means for the transportation of portable objects that allow the loading of a portable object so as to position the portable objects with chips in the slots of the mobile device, and convey these portable objects to a zone that is suitable for reception of the personalising data, characterised in that it includes:
at least one electrical power-supply element between a moving object attached to the mobile device and a fixed element of the machine;
in the mobile device or in portable objects loaded into the slots of the mobile device, second communication means to establish wireless communication with the first communication means and to receive the personalising data and the addressee data, these second communication means being powered electrically via the said power-supply element, and
identification means associated with each item of personalising data, and means for storage of the personalising data in the portable object whose addressee or to identify data corresponds to that of the slot or of the portable object.

It is thus possible to process a high number of cards on a moving device (of the drum type for example, in the case of rotation) with a maximum data bit-rate, while the server managing the personalising process can advantageously be placed outside of the mobile part.

According to another particular feature, the device is mobile in rotation, with the machine having means for driving in rotation in order to rotate the mobile device about an axis of rotation while the said computer system remains static, the electrical power-supply element of the mobile device including a first rotating part attached to the mobile device, and a second part extending the first part, which is fixed in rotation in relation to the mobile device.

According to another particular feature, the mobile device includes routing means, employed to route personalising data to the slots, by means of the addressee data, where each of the slots is equipped with contact-type or contactless means to communicate with an electronic chip on one of the portable objects.

According to another particular feature, the personalising machine can include:
first identification means to identify a given slot in relation to a loading position on the transportation means;
second means for identification of the portable object loaded or to be loaded into the given slot, adapted to acquire an identifier of this portable object that corresponds to the addressee data;
means to transmit the acquired identifier of the portable object (and specific to the personalising operation) to the computer controlled system; and
an association module in the computer controlled system to associate personalising data with the given slot, the association module being programmed to extract personalising data using the acquired identifier, and to transmit the personalising data thus extracted in association with the addressee data in order to route the extracted personalising data to the said given slot.

According to another particular feature, the association module extracts the personalising data by looking up a correspondence table stored in the computer controlled system, by using the acquired identifier as an entry key to the correspondence table.

According to another particular feature, the first and second communication means have a maximum capacity for the transmission of data exceeding several hundreds of Megabits per second.

According to another particular feature, the identifier specific to the personalising operation is erased from the memory of the chip of the portable object in order to prevent any repeat personalising operations.

According to another particular feature, the control module includes means for controlling at least one angular position adopted by the mobile device.

According to another particular feature, the control module includes detection means to continuously monitor the angular position adopted by the mobile device.

According to another particular feature, the mobile device forms a drum with slots for portable objects distributed around the axis of rotation.

According to another particular feature, the second communication means are placed opposite to the first communication means, in a position adjacent to the axis of rotation of the mobile device.

According to another particular feature, the second communication means include a radio wave receiver of the WiFi type connected to a data distributor connected in the mobile device to a plurality of processing devices, each coupled to at least one of the slots to transfer personalising data, received via the distributor, to the portable objects housed in the corresponding slots.

According to another particular feature, the distributor stores, in a memory, a table of IP addresses for each of the processing devices, and includes means to distribute received personalising data via the transmission element to the processing devices by looking up the table, and using IP address indicators supplied by the computer controlled system.

According to another particular feature, each processing device is linked to the computer controlled system and is positioned radially in the rotating mobile device, the computer system controlling the personalising process used to manage all of the portable objects housed in the slots of the mobile device.

According to another particular feature, the second communication means include at least one radio wave transmitter of the WiFi type that is used to render account of the successful completion of each personalising operation on a portable object performed in the mobile device.

According to another particular feature, the personalising machine includes a line for transfer of the portable objects with chips in order to insert and extract the portable objects in relation to the mobile device, the axis of rotation of the mobile device being positioned transversally in relation to the transfer line, and each transmission element lying in a favoured direction parallel to the axis of rotation.

According to another particular feature, the communication means of the computer controlled system are programmed to transmit personalising data that include numerical data, graphical data or alphanumeric data, or any combination of these data types.

According to another particular feature, the first communication means are programmed to receive messages transmitted by the second communication means, and to identify, in such a message, information that is representative of a portable object to which the message relates.

According to another particular feature, the system orders the sending of personalising data to a given portable object after reception of a message that includes a request for personalising of a coming portable object to be personalised and/or after reception of a message that includes an acknowledgement of the end of personalising of a portable object that is in the process of being personalised.

Thus, the processing rate of the personalising machine is advantageously high and the relevant personalising data can be transmitted as soon as the chip card is ready to be personalised.

According to another particular feature, the second communication means are distributed in several communication units, each incorporated into the portable objects or coupled to a unique portable object slot, each of the communication units of the second communication means sending a message of declaration that includes a request for personalising a given portable object when the given portable object is received in the slot associated with this communication unit, and the first communication means being programmed to receive the messages of declaration, and the system commands the dispatch of personalising data to the given portable object after reception of the personalising request.

The invention, with its characteristics and advantages, will be understood more clearly on reading the description that follows, which is provided with reference to the appended drawings in which:

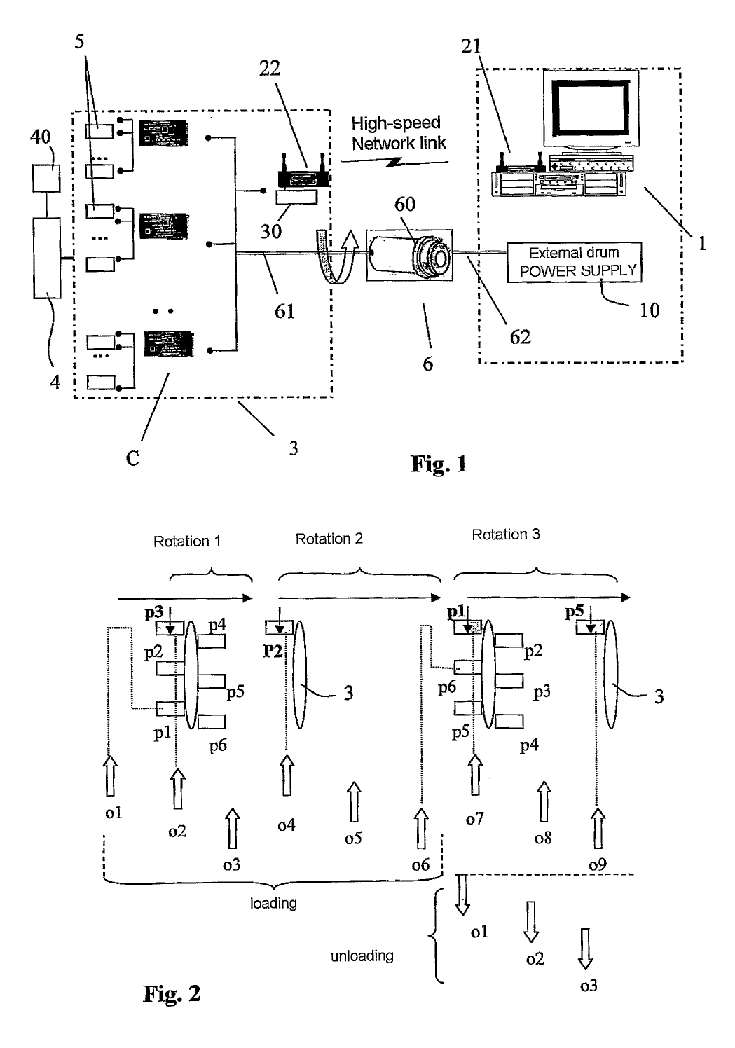

FIG. 1 schematically illustrates an embodiment of the invention;

FIG. 2 shows an example of load-unload cycles for a personalising machine according to the invention;

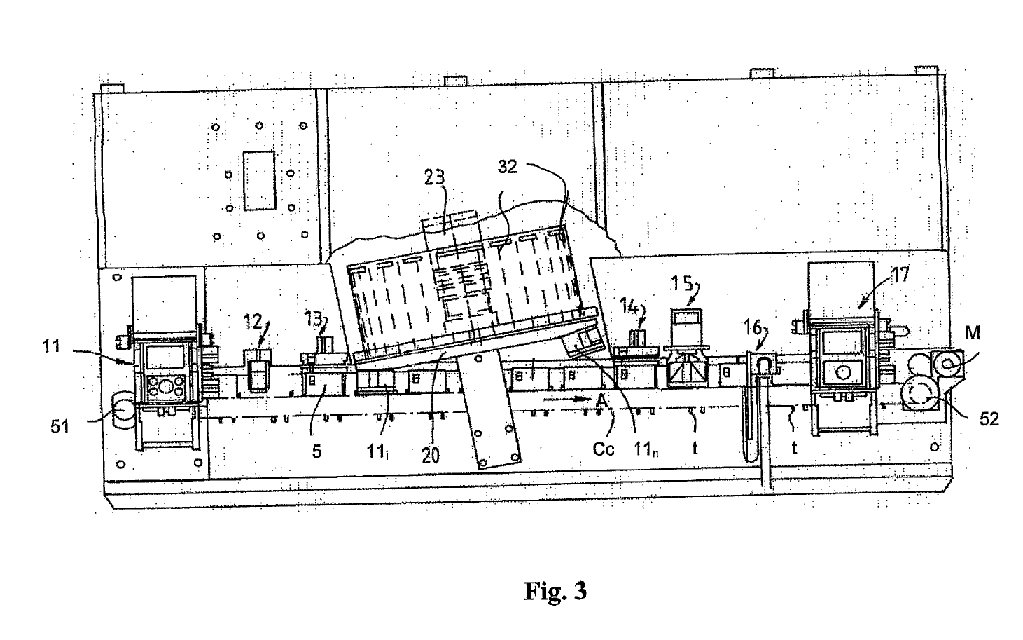

FIG. 3 represents a view from above of a machine according to the invention;

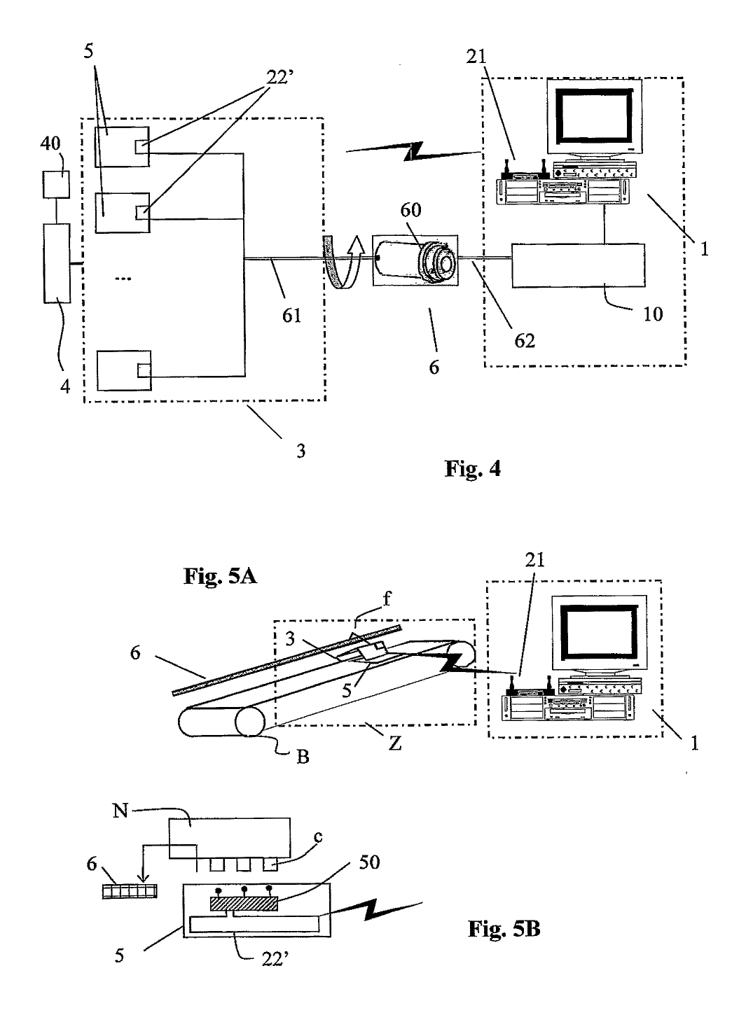

FIG. 4 represents an alternative embodiment of a personalising machine according to the invention;

FIGS. 5A and 5B show an additional example of embodiment of the invention.

### DESCRIPTION OF THE PREFERRED EMBODIMENTS OF THE INVENTION

The personalising machine, which will be described with reference to FIGS. 1 and 2, includes a static part and a mobile part in rotation. This type of machine can include a transfer path formed by a continuous toothed belt Cc running between two end pulleys 51, 52 of which one is driven by a motor M. Other means of conveyance can naturally be used, as will be appreciated by those skilled in the art.

The machine allows personalising at high processing rate of chip cards 5 or of portable objects equipped with a chip. A computer control system 1 fitted with communication means 21 is used to centrally control the personalising of several cards 5, by supplying specific data, known as personalising data, in accordance with the addressees of the cards 5. This system 1 is positioned in the static of fixed part, as illustrated in FIG. 1.

The communication means 21 of the computer control system 1 are used to transmit personalising data. The machine advantageously includes at least one rotating device 3 that includes the portable object 5 slots 32. Each of the slots 32 is equipped with contact-type or contactless means to communicate with an electronic chip on one of the portable objects 5.

In a preferred embodiment of the invention, a rotating connection element 6 is used exclusively for the electrical powering of the rotating device 3, while communication means 22 fitted in the device 3 remotely receive the personalising data transmitted by the system 1 via the communication means 21 of the control system 1. The data transmission is therefore accomplished wirelessly, with a bit-rate that can exceed several hundreds of Megabits per second and preferably at least equal to 1 Gbit/s, which renders the processing rate very high for a machine with a rotating device 3.

In association with the personalising data, the communication means 21 of the system 1 transmit addressee/addressing data in order to route the personalising data to the correct slot 32 where the portable object 5 is housed, whose chip will then receive the personalising data. The communication means 22 of the mobile device 3 can be powered electrically via the power-feed element 6.

The rotating device 3 is fitted with means for routing the personalising data to the chip card slots 32 that correspond to the addressee data associated with each item of personalising data.

In an embodiment of the invention, a connection device 11i is provided in order to place the card 5 in the correct conditions for reception of the personalising data. This device 11i is fitted with a connecting head with which a card 5 is associated with a view to personalising it. The connection device 11i can be kept in the rotating device 3, and will include a mobile loading/guidance part, or can be removable in relation to a card slot 32 of the rotating device 3.

The personalising machine advantageously includes means 4 for driving in rotation in order to rotate the mobile device 3 around an axis 23 of rotation, while the said computer system 1 remains static. These means 4 for driving in rotation are associated with a control module 40. In an embodiment of the invention, the control module 40 includes means for controlling at least one angular position adopted by the mobile device 3. Thus, correct positioning of the rotating device can be controlled, in particular for the loading/unloading phases of the cards 5.

Having a mobile device 3 to receive the cards to be personalised and to receive data at a very high bit-rate considerably increases the personalising processing rate, so that a larger number of cards can be processed in a given period compared to the existing devices. Using wireless transmission means that one is not limited to lower communication speeds, as encountered with rotating connectors. The mobile device 3 forms a drum with slots 32 for chip cards 5 distributed around its axis of rotation 23.

The personalising machine can remain compact, as illustrated in FIG. 2. Spacing lugs t are mounted on the endless belt Cc, at regular intervals in pairs, where the distance between two consecutive spacing lugs t corresponds to the length of a portable object of the size of a credit card hereinafter called a chip card 5.

In the non-limiting example of FIG. 2, each pair of spacing lugs t separated by a credit card length is positioned in relation to the following pair by a shorter length. The spacing lugs t are used to hold portable objects 5 during the movement on the outward part of the path represented by the arrow A, and the driving of the chip cards from a position to the next. From a batch of stacked cards, an unstacking device 11 is used to distribute the cards, and to insert them, one by one, between each pair of spacing lugs 31. The cards 5 thus inserted into the transfer path A are then brought to an electric test position 12 which is used, by simple electrical test, to remove any bad cards thus ensuring a first rapid detection, in a time of the order of barely 0.5 seconds, for example.

The unstacker 11 can include several entry magazines which allows continuous loading of the machine, the changing magazines taking place in masked time. In an embodiment of the invention, each magazine is removable with a content of the order of 500 cards. The tested cards 5 are then transferred to an ejection position 13, which is used to eject the bad cards. The cards that have successfully passed the electric test are then transferred from the ejection position 13 to the personalising position. This personalising position includes a rotating device 3 whose axis of rotation 23 is horizontal and parallel to the support platform of the transfer line Cc, t. Alternatively, it can be inclined in relation to the transfer path A.

On the periphery of the rotating device 3, a plurality of connection devices 11i, 11n are provided which are dimensioned to be slightly smaller than the cards 5 and with a space between their outer edge and the toothed belt Cc. A jack device or equivalent actuator device is used to push each card 5 onto the rotating device 3, as soon as the card 5 has been brought to the reception zone of the connection device 11i making contact with the fixed surfaces of the connection device. This jack is placed at the position for insertion and removal of the cards.

In the embodiment of FIG. 2, each device 11i for connection to a chip card 5 includes guidance means and connection means attached to the rotating device 3. Such means are described in document EP 0 797 167 for example. With each connecting head of a connection device 11i there is associated an electronic card which is used for personalising 32 and which is positioned, for example, on the opposite face of the rotating device 3 and which is oriented radially to the entry of this mobile device 3 rotating around its axis 23.

After the personalising step has been completed, the connection device 11i is brought, during the rotation of the mobile device 3, to the position for insertion and removal of the cards. The jack is operated in order to raise the connecting head. This frees the chip card 5 and then, by a movement of the belt Cc in the direction of the arrow A in FIG. 3, moves the personalised card and at the same time brings the next chip card to the connection device 11i, which has just completed the personalising process. The personalised card exiting from the rotating device 3 is then transported by the belt Cc to the ejection position 14. This ejection position 14 is used to remove the cards 5 for which personalising has been incomplete or defective. In an embodiment of the invention, if the personalising process has succeeded, the chip card 5 is transferred to a turning position 15 so that it can be marked graphically on its other face (an ink marking process for example) at a marking position 16.

Finally, still referring to FIG. 3, the card can be transported to a conventional stacker device 17, where it is stacked in a multiple magazine functioning according to the same principle as the unstacking device 11 but in the opposite sense. The rotating device 3 can thus include a large number of connection devices 11i each associated with a personalising device, which manages the personalising of the chip card 5 inserted by the transfer belt Cc into the connection device 11i to which the personalising card is linked. The rotating device 3 can thus include, for example, 32 or 16 connection devices 11i associated with the same number of personalising devices.

In order to allow transfer of the personalising data to the exact slot 32 where the chip card 5 or the corresponding portable object with chip is located, the personalising machine can advantageously include:
first identification means (an optical detector, for example, or any detector of the angular position of the mobile device 3) in order to identify a given slot 32 in relation to a loading position on the transportation/loading means;
second means for identification of the chip card 5 loaded or to be loaded into the given slot 32, adapted to acquire an identifier of this chip card 5, where this identification can be deduced, for example, from a given order of arrival of the chip cards 5;
means to transmit the acquired chip card 5 identifier to the computer control system 1; and
an association module in the computer control system 1, used to associate personalising data with the given slot 32, the association module being programmed to extract personalising data using the acquired identifier and to transmit the personalising data thus extracted in association with addressee data in order to route the extracted personalising data to the said given slot 32.

As will be appreciated by those skilled in the art, the means for correlating the chip card 5 to be personalised, and the sending to the associated slot 32 of the personalising data, can vary in their nature (see the description in document EP 1 228 481, for example). A listing of the order of passage of the chip cards 5 and a listing of the successive slots to be loaded can be used to establish the association between personalising data to be written to the chip cards 5 and the slots 32 to which these data are to be routed. The transmission of the personalising data takes account of the type of physical routing used to communicate between the static computer system 1 and the processing devices C. Each personalising data processing device C can be used to supply several writing/programming positions formed at the slots 32.

Each of the connection heads can be counted by a detector which returns this information to the control module 40. In an embodiment, for the insertion and the removal of the cards, the means for loading the chip cards are also used to position the chip cards 5 in the slots 32 of the rotating device 3 according to an alternating pattern of even and odd slots respectively. The alternating parity of the filling/emptying method of the said invention can be generalised to any filling/emptying method with a modulo number that is divisible by the programming position number. In another embodiment of the invention, all the slots 32 are loaded in succession, one after the other. In the first embodiment (alternating loading), the loading means are used to insert chip cards 5 into a first series of slots separated two by two by an intervening slot when the mobile device 1 does a first rotation, and are used to insert chip cards 5 into a second series of slots that correspond to the intervening slots when the mobile device 1 continues to complete a second rotation. During the first rotation, only the cards in the slots 32 of the first series are removed and replaced by cards to be personalised. During this rotation, personalising is effected for the cards 5 connected to the slots 32 of the second series. During the second rotation, since these cards 5 have completed their personalising process (all the data having been received), are removed and replaced by new cards 5.

According to the example of FIG. 2, a first series o1, o2, o3 of chip cards 5 can be loaded at odd slots of the mobile device 3 during a first rotation, the arrival of these slots at the unloading position capable of being established according to the respective pendulum positions p1, p3, p5 of the mobile device 3 associated with loading of these odd slots. During the following rotation, a second series o4, o5, o6 of chip cards 5 can be loaded at even slots of the mobile device 3. The pendulum positions p2, p4, p6 of the mobile device 3 also act in this case to determine which slot 32 is in a position to be loaded. A loading/unloading cycle can be summarised by the following table, for a simple case of 6 slots:

| Portable object | | | |
|---|---|---|---|
| with chip | Pendulum position | personalising data | Associated slot |
| o1 | p1 | D_o1 | 1 |
| o2 | p3 | D_o2 | 3 |
| o3 | p5 | D_o3 | 5 |
| o4 | p2 | D_o4 | 2 |
| o5 | p4 | D_o5 | 4 |
| o6 | p6 | D_o6 | 6 |

It can be seen that with each pendulum position p1, p2, p3, p4, p5, p6 there can be associated a slot identifier 32, allowing the computer control system 1, which receives the pendulum position information, to transmit to a given slot, among the personalising data D_o1, D_o2, D_o3, D_o4, D_o5, D_o6, only that associated with the portable chip object housed in the given slot 32. Typically, chip cards 5 arrive linearly in the position for loading or insertion of the cards 5. Their order of arrival is therefore known to the system 1. The latter is in possession of a correspondence table that is used to list the pendulum positions p1, p2, p3, p4, p5, p6 of the slots 32 predicted for each of the cards 5 arriving in the planned order.

After two rotations, the first chip card 5 to have been loaded can be unloaded. The unloading or removal position can be located beside or in the same place as the loading position. In this way, the loading order is the same as the unloading order of the chip cards 5 and there is no loss of time associated with useless rotations of the mobile device 3. Referring to FIG. 2, it can be seen that for two complete rotations, the slots 32 of the mobile device 3 can each have been loaded with a chip card 5. The portable objects or cards loaded o1, o2, o3, o4, o5, o6, o7, o8, o9 during the rotations come from the means of conveyance of the personalising machine, and unloading is effected in the same order as loading. Initially, the loading position will therefore insert the chip cards 5 in succession into the slots 32 that correspond to the odd pendulum positions p1, p3, p5 and then into the slots 32 that correspond to the even pendulum positions p2, p4, p6, as indicated in the above table. Naturally, the mobile device can include many more slots 32 with, for example, 18 or 36 programming positions each equipped with a slot 32 for personalising the cards 5.

A chip card 5 loaded in its slot 32 can thus be personalised during a period exceeding the length of a complete rotation. A large volume of personalising data can be transferred during this period.

Referring to FIG. 1, the processing devices C have a high processing speed, with a frequency of the order of 220 MHz for example, for their processor (or equivalent processing unit). The computer controlled system 1 has a frequency of 4 GHz for example, i.e. 18 times higher. It can be seen that a mobile device 3 equipped with 18 processing devices C allows that no speed is lost in relation to the data bit-rate. In the example of FIG. 1, one or more wireless links of the IP type are provided (bit-rate over 1 Gbit/s) to link a static central computer to the rotating device 3, these communication means 21 being linked to an Ethernet card or equivalent communication network interface (card network, interface managing the IP protocol, etc.) on the computer.

In an alternative embodiment, the mobile device 3 can be provided indirectly with the means 22′ to communicate. In particular, these communication means 22′ can be mounted in the portable objects with chips, such as chip cards 5, as illustrated in FIG. 4. In another alternative embodiment, the communication means 22 receiving the personalising data transmitted from the static part are provided at the different processing devices C. For example, the addressing/addressee data supplied by the communication means 21 of the control system 1 allow reception of the personalising data and their processing at one only of the processing devices C.

In the example of FIG. 1, the communication means 22 are associated with or include a data distributor 30 (of the “switch hub” type for example) connected, in the mobile device 3, to a plurality of processing devices C. The processing devices C, connected in parallel with the distributor 30, are themselves each coupled to at least one of the slots 32 of the mobile device 3, in order to transfer personalising data received via the distributor 30 to the chips of the cards 5 housed in the corresponding slots 32. A connecting head is provided in each slot 32 in order to write the personalising data to the chip card 5. This write operation can take place via a contact-type or contactless interface of the connecting head.

In the example of FIG. 1, which is in no way limiting, the second communication means 22 are placed opposite to the first communication means 21 fitted in the system 1, in a position adjacent to the axis 23 of rotation of the mobile device 3. The second communication means 22 include a radio wave receiver of the WiFi type, connected to the distributor 30. A transmitter of the WiFi type can be combined with the receiver so as to allow bi-directional communication. These second communication means 22 can possible include a module for reading the chip cards 5 loaded on the mobile device 3, and are used to send a report on the state of the personalising process to the computer control system 1.

During the personalising procedure, at least one card identifier 5 is loaded into one of the processing devices C, as well as the personalising data associated with this identifier. Certain information concerning the next chip card 5 to be personalised by the same device C can also be sent. The information received in advance for the next card 5 allows the processing device C to check the identifier of this next card for example. This is useful so that a processing device C can manage several slots 32, which is several connection heads. This enables the device C to route the personalising data coming from the distributor 30 in accordance with the identifiers, an identifier being associated with one only of the slots 32 each time.

It can be seen that the cards or objects to be personalised must be monitored precisely in order not to record data relating to a first individual, and then print information relating to a second individual on this card or object. This is why the order of insertion and removal of the chip cards 5 must be managed centrally at the computer controlled system 1. The personalising machine according to the invention is used to manage this while also ensuring a very high processing rate.

The distributor 30 is able to store, in memory, a table of IP addresses for each of the processing devices C, and includes means for distributing the personalising data received via the transmission element 2 to the processing devices C by looking up the table. IP address indicators supplied by the computer control system 1 in the data frames are used for this purpose.

It can be seen that the communication means 21 of the system 1 of the static part are able to receive messages transmitted by the second communication means 22, 22′ and to identify, in such a message, information that is representative of a portable object 5 to which the message relates. For example, in an embodiment of the invention, the system 1 commands the dispatch of personalising data to a given portable object 5 after reception of at least one particular message. This particular message (or messages) can include a request for personalising a coming portable object to be personalised. They can alternatively or also include an acknowledgement of the end of personalising of a portable object 5 that is in the process of being personalised.

Referring to FIG. 4, the communication means 22′ are provided on the cards 5 in order to allow a dialogue with the computer control system 1. The communication means 21 of the computer system 1 can include an addressing module that is used to target the cards 5 to be personalised. The advantage of this exemplary embodiment is that no routing is used in this case at the mobile device 3. The processing devices C can be simply mounted remotely in the chip cards 5, as will be appreciated by those skilled in the art. The communication means 22′ of the mobile device 3 can be powered electrically via the power-feed element 6 when the portable objects 5 are loaded into the slots 32 of the mobile device 3 and thus connected to the electrical power supply of the mobile device 3.

The second communication means 22′ can be distributed in several communication units, each incorporated into the portable objects 5, as illustrated in FIG. 4. These communication units can alternatively be coupled to a single portable object slot 32. When a given portable object 5 is received in a slot 32 of the mobile device 3, the associated communication unit of the second communication means 22′ can send a message of declaration that includes a request for personalising of the given portable object 5. The first communication means 21 receive the messages of declaration, and the system 1 is able to command a dispatch of personalising data to the given portable object 5 after reception of the personalising request.

In a preferred embodiment of the invention, at least one electrical power-supply element of the mobile device 3, a rotating connection element 6 for example, is connected to an external power supply 10 of the device 3 forming the rotating drum. This power feed 10 can be obtained from a connector located in the static part. The element 6 can include a first part 61 attached in rotation to the mobile device 3, and a second part 62 extending the first part 61, which is fixed in rotation in relation to the mobile device 3. A connection of the rotating connector type is created by a connector 60 with contacts, of a type that is known as such.

Referring to FIGS. 5A and 5B, the mobile device 3 is able to move in translation for example, using a transportation strip B or using motor-driven drive means. The portable object slot or slots 5 of the mobile device 3 can correspond to a position of contact with an interface c of a shuttle N on the mobile device 3. Each of the shuttles N is thus designed to make contact with the contacts of the chip 50 and thus mate with the portable chip object. The shuttle N includes a contact-type interface c for example, making contact with a chip card 5, as illustrated in FIG. 5B. When the shuttle N is connected via its interface c to the chip 50, the power feed of the second communication means 22′ present in the chip 50 is connected via the contact of at least one wiper contact f of the shuttle N with the electrical conductor forming the power-supply element 6, as illustrated in FIG. 5A. This element 6 can travel along the transportation strip B, and can be of the galvanic or direct-current type.

In this alternative embodiment, it can be seen that the portable object slot or slots 5 move with the shuttles N, and are therefore mobile in translation for example. The portable objects 5 are brought to a zone Z which allows reception of the personalising data. This zone Z can be a WiFi reception zone for example, in which the personalising addressee data and the identifiers (addressee data) are indeed received by the chip 50 addressee. To this end, it is necessary that the chip 50 should be powered electrically via the power-supply element 6 and the shuttle N. A WiFi management program can be provided in the chip 50 for selective reception of the personalising data. This program can transmit the personalising identifier and can check that the data that it receives via the communication means 22′ of the chip 50 are associated with the personalising identifier. If this is the case, a write can be effected to a memory of the chip 50 of the portable object. Otherwise, the received data is rejected. A command for erasure of the personalising identification can be transmitted by the program at the end of the personalising process, in order to prevent undesirable repeat personalisation.

The program on the chip 50 can be used, using a key for example, which will then be erased, to write to a protected zone of the memory. After the personalising process, this zone of the memory will no longer be accessible on write.

One of the advantages of the personalising machine is that is optimally manages the bit-rate capacity of the data stream from the computer controlled system 1 and that it is able to process a considerable volume of chip cards or similar portable objects. The machine can be used to process several chip cards 5 in parallel with no problem of size. Wireless communication allows rapid personalising to be effected, even for large volumes of data to be written to the chips on the cards 5. More than 6000 cards 5 can be programmed per hour.

1. A machine for the personalising, at high processing rate, of portable objects equipped with a chip, which includes a computer control system fitted with first communication means to send personalising data, and addressee data in order to route the personalising data to one of the portable objects, at least one mobile device fitted with portable object slots that are mobile, and means for the transportation of portable objects that allow the loading of a portable object so as to position the portable objects with chips in the slots of the mobile device, and convey these portable objects to a zone that is suitable for reception of personalising data, including:
at least one element for the feeding of electrical power between a moving object attached to the mobile device and a fixed element of the machine; and
in the mobile device, or in portable objects loaded into the slots of the mobile device, second communication means used to establish wireless communication with the first communication means, and to receive the personalising data and the addressee data, these second communication means being powered electrically via the said power-feed element.
identification means associated with each item of personalising data and means for storage of the personalising data in the portable object, whose addressee or identifier data corresponds to that of the slot or of the portable object.

2. The personalising machine according to claim 1, wherein the device is mobile in rotation, the machine having means for driving in rotation in order to rotate the mobile device around an axis of rotation while the said computer system remains static, the element for electrical powering of the mobile device including a first part attached in rotation to the mobile device, and a second part extending the first part, which is fixed in rotation in relation to the mobile device.

3. The personalising machine according to claim 1, wherein the mobile device incorporates the second communication means, and includes routing means to route personalising data to the slots, by means of the addressee data, each of the slots being equipped with contact-type or contactless means to communicate with an electronic chip on one of the portable objects.

4. The personalising machine according to claim 1, that includes:
first identification means to identify a given slot in relation to a loading position on the transportation means; —second means for identification of the portable object loaded or to be loaded into the given slot, adapted to acquire an identifier of this portable object that corresponds to the addressee data,
means to transmit to the computer control system, the acquired portable object identifier; and—an association module in the computer control system, to associate personalising data with the given slot, the association module being programmed to extract personalising data using the acquired identifier, and to transmit the personalising data thus extracted in association with the addressee data in order to route the extracted personalising data to the said given slot.

5. The personalising machine according to claim 4, wherein the association module extracts the personalising data by looking up a correspondence table stored in the computer control system, and using the acquired identifier as an entry key to the correspondence table.

6. The personalising machine according to claim 1, wherein the first and second communication means have a maximum capacity for the transmission of data exceeding several hundreds of Megabits per second.

7. The personalising machine according to claim 2, which includes a module for, controlling the means for driving in rotation, the control module including means for controlling at least one angular position adopted by the mobile device.

8. The personalising machine according to claim 7, wherein the control module includes detection means to continuously monitor the angular position adopted by the mobile device.

9. The personalising machine according to claim 1, wherein the mobile device forms a drum with slots for portable objects distributed around the axis of rotation.

10. The personalising machine according to claim 1, wherein the second communication means are placed opposite to the first communication means, in a position adjacent to the axis of rotation of the mobile device.

11. The personalising machine according to claim 1, wherein the second communication means include a radio wave receiver of the WiFi type connected to a data distributor connected, in the mobile device, to a plurality of processing devices each coupled to at least one of the slots, in order to transfer personalising data received via the distributor to the portable objects housed in the corresponding slots.

12. The personalising machine according to claim 11, wherein the distributor stores, in a memory, a table of IP addresses for each of the processing devices, and includes means to distribute personalising data received via the radio wave receiver to the processing devices by looking up the table, and using IP address indicators supplied by the computer control system.

13. The personalising machine according to claim 11, wherein each processing device is linked to the computer control system and is positioned radially in the mobile rotating device, the personalisation computer control system being used to manage all of the portable objects housed in the slots of the mobile device.

14. The personalising machine according to claim 1, wherein the second communication means include at least one radio wave transmitter of the WiFi type that is used to render account of the successful completion of each personalising operation on a portable object performed in the mobile device.

15. The personalising machine according to claim 1, which includes a transfer line for the portable objects in order to insert and extract the portable objects in relation to the mobile device, the mobile device having an axis of rotation that is positioned transversally in relation to the transfer line.

16. The personalising machine according to claim 1, wherein the first communication means fitted in the computer control system are programmed to transmit personalising data that includes numerical data, graphical data or alphanumeric data, or any combination of these data types.

17. The personalising machine according to claim 1, wherein the first communication means are programmed to receive messages transmitted by the second communication means and to identify, in such a message, information that is representative of a portable object to which the message relates.

18. The personalising machine according to claim 17, wherein the system orders the sending of personalising data to a given portable object after reception of a message that includes a request for personalising of a coming portable object to be personalised and/or after reception of a message that includes an acknowledgement of the end of personalising of a portable object that is in the process of being personalised.

19. The personalising machine according to claim 1, wherein the second communication means are distributed in several communication units each incorporated into the portable objects, each of the communication units of the second communication means sending a message of declaration that includes a request for personalising of a given portable object when the given portable object is received in the slot associated with this communication unit, the first communication means being programmed to receive the messages of declaration, and the system controlling the dispatch of personalising data to the given portable object after reception of the personalising request.

20. The personalising machine according to claim 1, wherein the second communication means are distributed in several communication units coupled to a single slot, each of the communication units of the second communication means sending a message of declaration that includes a request for personalising of a given portable object when the given portable object is received in the slot associated with this communication unit, the first communication means being programmed to receive the messages of declaration, and the system controlling the dispatch of personalising data to the given portable object after reception of the personalising request.

21. The personalising machine according to claim 4, wherein the identifier of the received portable object is specific to the personalising operation, this identifier specific to the personalising operation being erased from the memory of the chip of the portable object in order to prevent any repeat personalising operations.
